(19) United States
(12) Patent Application Publication
(10) Pub. No.: US 2012/0164955 A1
(43) Pub. Date: Jun. 28, 2012

(54) Method and Apparatus for Cell Control

(75) Inventors: Mehdi Amirijoo, Linkoping (SE); Pål Frenger, Linkoping (SE); Harald Kallin, Sollentuna (SE); Johan Moe, Mantorp (SE); Kristina Zetterberg, Linkoping (SE)

(73) Assignee: TELEFONAKTIEBOLAGET LM ERICSSON (PUBL), Stockholm (SE)

(21) Appl. No.: 13/394,443

(22) PCT Filed: Sep. 10, 2009
(86) PCT No.: PCT/SE09/51008

§ 371 Date: Mar. 6, 2012

(51) Int. Cl. H04W 24/00; H04W 88/08

(52) U.S. Cl. 455/67.11; 455/561

(57) ABSTRACT

In a method and an apparatus for determining when a cell of a cellular radio system can enter a discontinuous transmission mode is provided. By evaluating qualities from both the cell and neighboring cells for a number of positions and calculating a statistically expected quality distribution of the evaluated qualities conditioned on that certain cells are in discontinuous transmission mode it is possible to generate a distribution which can be compared with at least one requirement thresholds. Based on the comparison it is possible to determine if first cell can use discontinuous transmission mode and still fulfill the requirements.

### TECHNICAL FIELD

The present invention relates to a method and an apparatus for controlling the status of a cell in a cellular radio network. In particular the present invention relates to a method and an apparatus for determining when a cell can enter a low activity transmission mode.

### BACKGROUND

Energy efficiency in telecommunication systems is becoming more and more important. The solutions are many, and they are found in protocols, algorithms and hardware etc. Normally traffic load in the radio network variegate; resource utilization is fluctuating between night (normally low) and day (normally high); in night time the spare capacity is running unutilized in the radio network. Hence one way to save energy is to halt partial radio resources during e.g. 22.00 and 04.00.

However, legacy technologies are not built specifically with energy efficiency in mind so solutions are often gross grained. For example it may only be possible to block a complete cell. Using this approach may result in loss of, so it must first be ascertained that there is radio coverage in the area served also after turning off a cell. Since determining coverage can be a difficult task, complete turn off of a cell is not commonly used. Instead redundant resources like a second carrier can be turned off.

In previous networks like 2G (e.g., GERAN) and 3G (e.g., UTRAN) it is not common that operators fully explore the possibility to save energy by closing down one out of several technologies. This is mainly due to difficulties to foresee coverage and capacity impact. The problem would be diminished if operators spent considerable time and effort on drive/walk tests to completely exhaust all possibilities, but since many areas are located indoor, not reachable from outside, it only partially solves the problem. This means that energy consumption is still at an unnecessary high level in some areas during some periods.

Hence, there exist a need for a method and a device that enables efficient energy saving in a cellular radio system.

### SUMMARY

It is an object of the present invention to provide an improved method and apparatus for enabling substantial energy savings in a cellular radio system. In particular it is an object of the present invention to reduce or eliminate the problems as described above.

This object and others are obtained by the method and apparatus as set out in the appended claims.

In accordance with one embodiment a method for determining when a cell of a cellular radio system can enter a discontinuous transmission mode is provided. By evaluating qualities from both the cell and neighboring cells for a number of positions, and calculating a statistically expected quality distribution of the evaluated qualities conditioned on that certain cells are in low activity transmission mode, it is possible to generate a distribution which can be compared with at least one requirement thresholds. Based on the comparison it is possible to determine if first cell can use low activity transmission mode and still fulfill the requirements.

In accordance with the present invention a database is formed where the coverage impact of a cell in a cellular radio system is indicated. If a cell only adds capacity to the system and does not reduce coverage when it is inactivated this can be indicated in the database. The cells only adding capacity can be forced in low activity transmission and reception (sleep mode) at certain conditions. The data base can also comprise information about the cells indicating to what level the users that are normally served by a particular cell can be supported by the active surrounding cells.

By monitoring the demand for cell capacity and comparing the demand to the relation database capacity cells, which can be turned off without risking the coverage in the area defined by the same cell can be identified. Hereby a cell can be turned off without reducing coverage. This in turn will save energy and costs related thereto.

Hence, if a cell is not or is only lightly loaded it can be energy efficient to let other cells take over the UE management. This is enabled by provision of the cell relation database.

The invention also extends to a method and an apparatus for identifying and turning off cells that are identified in accordance with the above.

### BRIEF DESCRIPTION OF THE DRAWINGS

The present invention will now be described in more detail by way of non-limiting examples and with reference to the accompanying drawings, in which:

FIG. 1 is a view of a cellular radio system,

FIG. 2 is a view of an exemplary scenario where one UE collects measurements from one source radio base stations and a number of other radio base stations,

FIG. 3 is a view of a matrix used for determining possible status of a cell,

FIG. 4 is a view of exemplary conditioned Cumulative Distribution Functions,

FIG. 5 is a view of a cellular radio system having decision modules for determining the status of cells in the system, and

FIG. 6 is a flowchart illustrating some procedural steps performed when determining the possible status of a cell.

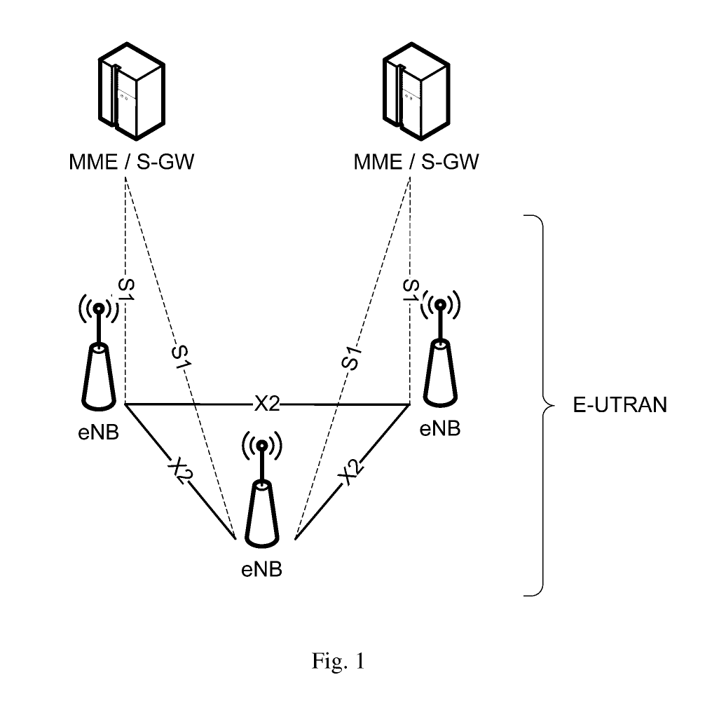

### DETAILED DESCRIPTION

The invention as described below is described in the context of overlapping technologies where an operator operates two or more radio technologies in parallel, for example WCDMA in combination with LTE. However, the invention also envisages the scenario where only one technology is used. In accordance with the present invention knowledge whether it is possible to turn off a cell of the network and while continuing to support the UEs of the network is used to save energy by turning off one or many cells.

Building a Quality Map of Supporting Neighbor Cells

For each cell a table of its neighbor cells coverage can be formed. This table will be referred to database or cell database herein. For each UE a cell entry is formed which stores one or more quality measurement containing the quality a UE would obtain if instead being connected to each of the neighbor cells.

The quality can be quantified in several ways, from simple models such as coverage or no coverage to more sophisticated quality measures like UE or cell measurements. Examples of measurements that can be used include but are not limited to RSRP, RSRQ, and channel sounding. It is also possible to use and store bandwidth estimations, for example 7 Mb. The bandwidth estimate can be formed based on direct translation from RSRP/RSRQ to bandwidth or to take the consequence of stopping a cell into account; and to add also the possible load that a stopped cell would cause to a neighbor cell.

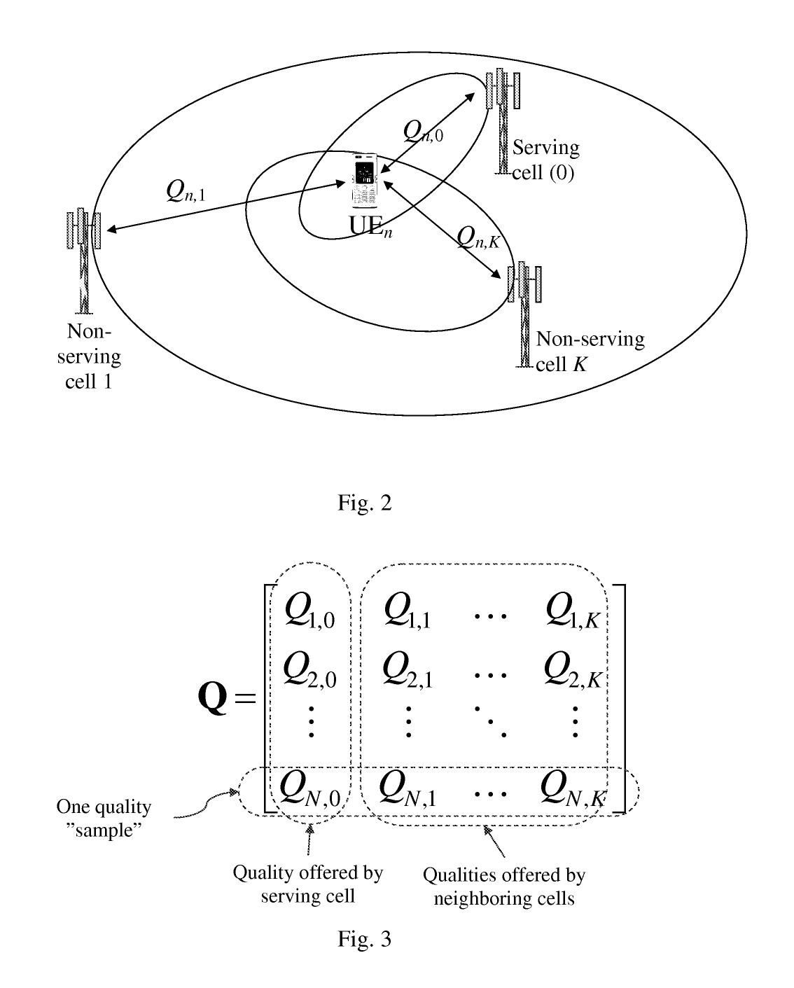

In FIG. 2 an exemplary scenario is depicted where one UE collects measurements from one source radio base stations and a number of other radio base stations to which the UE can connect. A large number of UEs and UE types manifest the measurement results to guarantee the validity of the result. Typically it is also important that all cell neighbors in the vicinity are active during the collection of measurement or the quality level will be inaccurate. This also implies that the database typically needs to be updated when a new cell/carrier is deployed or removed in the vicinity.

The quality can be retrieved in many ways, for example via UE measurements, e.g. RSRP or RSRQ measurements. Another solution is to use channel sounding, where the neighbor cells measure on the uplink. In accordance with one embodiment regardless of collection method, a quality measure is stored in the database for both the uplink and the downlink. For example a coverage indication, RSRP, RSRQ, estimated bandwidth etc. can be stored as quality measure.

The database can be seen as a matrix. In FIG. 3 an exemplary matrix Q is constructed in a serving cell consisting of K+1 columns where K is the number of neighbors of said serving cell. Column k represents the quality offered by cellₖ where k=0 is the index of the serving cell. The number of row may vary depending on the accuracy requested. In each row one UE sample is stored with the quality of the serving cell and the neighbors. This means that some columns may have no values since those neighbors contributed with no quality at the time for the sample. In FIG. 3 the matrix contains the quality measurements per UE sample. Each row contains the quality of the serving cell and zero or more neigbouring cells on the downlink and the uplink. When the matrix is considered stable as determined by some condition, e.g. enough samples have been collected; it can be used to calculate maximum conditional quality results.

Below one exemplary embodiment is described in more detail.

Let v be a cell condition vector so that vᵢ represents the state of the i:th cell and

$$v = \underbrace{[ {v}_{0} {v}_{1} … {v}_{K} ]}_{one on / off indicator per cell}$$

vᵢ=1 if the cell is active

vᵢ=0 otherwise

Apply the condition vector on sample n in matrix Q to get a maximum conditional quality as:

Q_{n,max|v}=max([Q_{n,0}v₀ Q_{n,1}v₁ . . . Q_{n,K}v_{K}])

Let Qₘₐₓ|v be the vector of size (N×1) of the maximum conditional qualities

Q_{max|v}=[Q_{1,max|v} Q_{2,max|v} . . . Q_{N,max|v]}^{T}

By constructing a series of v projections such that:
1 be the vector of size K+1 containing only ones
v{k} be the vector of size K+1 where element vₖ=0 and all other elements are 1
v{k, m} be the vector of size K+1 where elements bₖ and bₘ equals 0 and all other elements equals 1.

Compare the Cumulative Distribution Function (CDF) conditioned on different neighboring cell conditions
Q_{max|1} The reference case (all cells are on)
Q_{max|v{0}} The quality offered when only the serving cell is off.
Q_{max|v{0, k}} The quality offered when only the serving cell and neighboring cell k are off.
Q_{max|v{0, k, m}} The quality offered when only the serving cell and neighboring cells k and m are off. etc.

In accordance with one embodiment a minimum quality for a relative number of samples can be expressed. For example, the probability of achieving at least the quality qₘₘ (e.g. 1 kbps) must be less than pₘₐₓ (e.g. 0.001). From that one or more CDFs qualifies. When this requirement is fulfilled this means that it is possible to say that for a number of neighbours being active while others are sleeping it is possible to deactivate the cell.

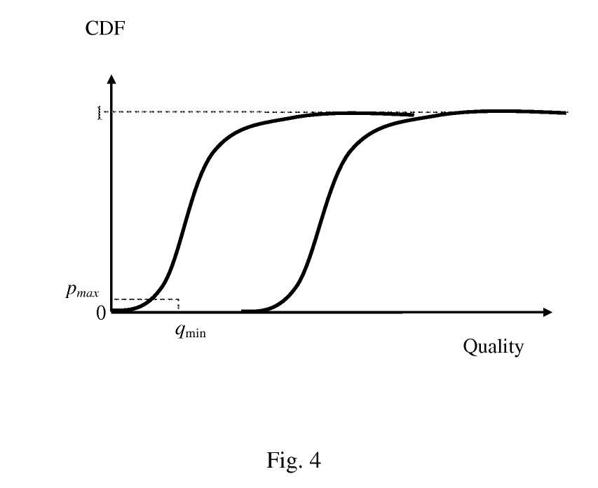

FIG. 4 depicts two exemplary CDFs. In FIG. 4 the leftmost CDF satisfies the conditions set whereas the rightmost does not.

Bringing a Cell to Sleep

A cell can be brought to sleep, i.e. set to discontinuous transmission and/or reception mode given that cell brought to sleep still satisfies the quality conditions. For example when the current Q matrix satisfies the quality requirement, which include information about which neighbor cells are on and off. A cell can be brought to sleep at any suitable time provided that the quality requirements are met. This will lead to a reduction in power consumption.

Wake a Cell

A cell in sleep mode can be activated at any suitable time. For example if the resource utilization in the surrounding cells is over some limit or it can be shown that it would be more resource efficient to start a particular cell.

The decision about brining a cell to sleep and waking the cell up can be implemented in a number of different manners depending on how the system is deployed and configured. An apparatus comprising a decision module for bringing a cell to sleep and waking a cell can for example be deployed either centralized such as in a in Domain manager OSS or Network Management System, RNC/BSC or decentralized in a radio base station RBS such as in a eNode in LTE.

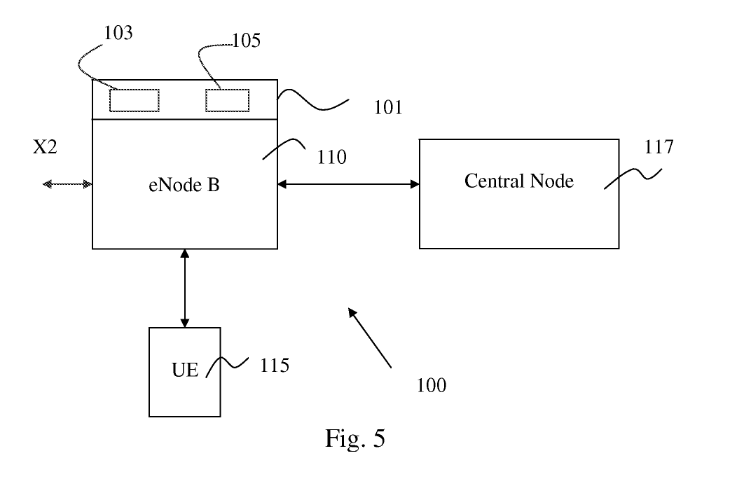

In FIG. 5 an exemplary decision module 101 deployed in a radio base station 110 of an LTE radio network 100 is depicted. The decision module comprises a unit 103 for monitoring the quality in the cell as received from UEs 115. For example the unit 103 can be adapted to generate a matrix such as the Q-matrix described above. Based on the current status of the quality in the cell and possibly also on the status of neighboring cells which for example can be received over the X2 interface or from a central node 117 a decision unit 105 is adapted to decide whether to bring the cell of the radio base station 110 into a sleep mode or to wake it up. In another exemplary embodiment the decision module can be located in the central node 117.

For example if a greedy algorithm is used it can be easy to have the decision module placed in eNodeB. The eNodeB continuously evaluates its resource utilization U and if U<threshold for example given by the operator it checks the status of Q matrix and if enough neighbors are active) so that the minimum quality can be guaranteed it goes to DTX. (sleep mode, or low transmission activity mode). The information about the status of neighboring cells can be collected via the X2 interface in an LTE system.

On the other hand it may be suboptimal to take the cell to DTX. Say that more than one cell are signaling low resource utilization, but they are dependant on each other (not all cells can be taken down), then it can be better to apply an optimization algorithm which is probably easier to run in a central node.

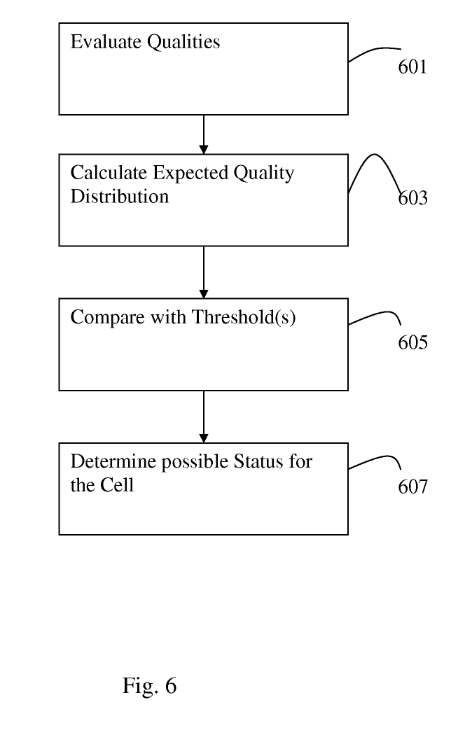

In FIG. 6 a flowchart illustrating some steps performed when determining when a cell of a cellular radio system can enter a low activity transmission mode in accordance with an exemplary embodiment is depicted. First, in a step 601, qualities from both the first cell and neighboring cells are evaluated for a number of positions. Next, in a step 603, a statistically expected quality distribution of the evaluated qualities is calculated. The expected quality distribution of the evaluated qualities can be conditioned on that certain cells are in discontinuous transmission mode. Next, in a step 605, the expected quality distribution is compared with at least one requirement thresholds. Finally, in a step 607, it is determined if the first cell can use discontinuous transmission mode in response to if the at least one requirement thresholds is fulfilled or not.

The method and apparatus as described herein leads to lower costs for energy running a telecom network since it guides to cells possible to turn of at low bandwidth utilization. The advantages offered by this invention include automatic pin-pointing of cells possible to turn of at low traffic.

1-14. (canceled)

15. A method to determine when a first cell of a cellular radio system can enter a low activity transmission mode, the method comprising:
evaluating qualities from both the first cell and neighboring cells for a number of mobile stations;
calculating a statistically expected quality distribution of the evaluated qualities;
comparing the expected quality distribution with at least one requirement threshold;
determining whether the first cell can use a discontinuous transmission mode based on whether the at least one requirement threshold is fulfilled.

16. The method of claim 15, wherein the evaluated qualities are determined when all neighboring cells are active.

17. The method of claim 15, wherein the evaluated qualities comprise one or more of:
coverage or no coverage;
User Equipment or cell measurements; and
bandwidth estimations.

18. The method of claim 15, wherein the expected quality distribution is updated when a new cell or carrier is deployed or removed in the vicinity of the first cell.

19. The method of claim 15, wherein the expected quality distribution is updated when a cell changes configuration parameters that affect cell coverage.

20. The method of claim 15, further comprising bringing a cell to a discontinuous transmission mode based on the determination and information about which neighbor cells are on and off.

21. The method of claim 15, wherein the calculated statistically expected quality distribution of the evaluated qualities is conditioned on that certain cells are in a discontinuous transmission mode.

22. An apparatus for determining when a first cell of a cellular radio system can enter a low activity transmission mode, the apparatus comprising:
means for evaluating qualities from both the first cell and neighboring cells for a number of mobile stations;
means for calculating a statistically expected quality distribution of the evaluated qualities;
means for comparing the expected quality distribution with at least one requirement threshold; and
means for determining whether the first cell can use a discontinuous transmission mode based on whether the at least one requirement threshold is fulfilled.

23. The apparatus of claim 22, wherein the apparatus is adapted to determine the evaluated qualities when all neighboring cells are active.

24. The apparatus of claim 22, wherein the evaluated qualities comprise or more of:
coverage or no coverage;
User Equipment or cell measurements; and
bandwidth estimations.

25. The apparatus of claim 22, further comprising means for updating the expected quality distribution when a new cell or carrier is deployed or removed in the vicinity of the first cell.

26. The apparatus of claim 22, further comprising means for updating the expected quality distribution when a cell changes configuration parameters that affect cell coverage.

27. The apparatus of claim 22, further comprising means for bringing a cell to a discontinuous transmission mode based on the determination and information about which neighbor cells are on and off.

28. The apparatus of claim 22, wherein the calculated statistically expected quality distribution of the evaluated qualities is conditioned on that certain cells are in a discontinuous transmission mode.

29. A radio base station configured to determine when a first cell of a cellular radio system can enter a low activity transmission mode, the radio base station comprising:
a monitoring unit configured to evaluate qualities from both the first cell and neighboring cells for a number of mobile stations and to calculate a statistically expected quality distribution of the evaluated qualities; and
a decision unit configured to compare the expected quality distribution with at least one requirement threshold and to determine whether the first cell can use a discontinuous transmission mode based on whether the at least one requirement threshold is fulfilled.

30. The radio base station of claim 29, wherein the monitoring unit is configured to determine the qualities when all neighboring cells are active.

31. The radio base station of claim 29, wherein the evaluated qualities comprise one or more of:
coverage or no coverage;
User Equipment or cell measurements; and
bandwidth estimations.

32. The radio base station of claim 29, wherein the monitoring unit is configured to update the expected quality distribution when a new cell or carrier is deployed or removed in the vicinity of the first cell.

33. The radio base station of claim 29, wherein the monitoring unit is configured to update the expected quality distribution when a cell changes configuration parameters that affect cell coverage.

34. The radio base station of claim 29, wherein the decision unit is configured to bring a cell to a discontinuous transmission mode based on the determination and information about which neighbor cells are on and off.

35. The radio base station of claim 29, wherein the monitoring unit is configured to condition the calculated statistically expected quality distribution of the evaluated qualities on that certain cells are in a discontinuous transmission mode.
